(19) United States
(12) Patent Application Publication
(10) Pub. No.: US 2015/0213656 A1
(43) Pub. Date: Jul. 30, 2015

(54) Driving Behavior Monitoring System

(71) Applicant: WUNELLI LIMITED, Portsmouth, Hampshire (GB)

(72) Inventor: Paul Rowan Stacy, Petersfield (GB)

(21) Appl. No.: 14/417,282

(22) PCT Filed: Jul. 26, 2013
(86) PCT No.: PCT/GB2013/052021

§ 371 Date: Jan. 26, 2015

(30) Foreign Application Priority Data
Jul. 26, 2012 (GB) 1213291.6

(51) Int. Cl. G07C 5/00; G07C 5/08

(52) U.S. Cl. CPC G07C 5/008; G07C 5/08

(57) ABSTRACT

A driving behaviour monitoring system (11) comprising an on-board diagnostics module (3) adapted to be mounted in a vehicle, the on-board diagnostics module comprising a vehicle usage monitor operative to monitor usage of the vehicle and to generate vehicle usage data based on at least one usage characteristic of the vehicle, the system further comprising a controller (5) and a driving behaviour scoring server (9) arranged to be in real-time communication with the controller via a telecommunications network, the on-board diagnostics module further comprising a transceiver operative to transmit the vehicle usage data to the server via the controller, the server comprising a database (12) on which vehicle usage data is stored, the server further comprising a data processor controlled by an algorithm such that the server is operative to generate an alert signal by processing the vehicle usage data generated by the on-board diagnostics module, the alert signal being indicative of a driving behaviour score, and wherein the server is operative to transmit the alert signal from the server to the controller for review by the driver.

The present invention relates to a driving behaviour monitoring system.

It can be desirable to monitor how a vehicle is used in order to be able to use the vehicle usage data for a supplementary purpose. One use of such vehicle usage data is to be able to calculate, or adjust, a vehicle insurance premium in dependence upon how the vehicle is being used. Another use of such vehicle usage data would be to provide feedback to the driver on how they are driving, for example, how safely they are driving.

According to a first aspect of the invention there is provided a driving behaviour monitoring system comprising an on-board diagnostics module adapted to be mounted in a vehicle, the on-board diagnostics module comprising a vehicle usage monitor operative to monitor usage of the vehicle and to generate vehicle usage data based on at least one usage characteristic of the vehicle, the system further comprising a controller and a driving behaviour scoring server arranged to be in real-time communication with the controller via a telecommunications network, the on-board diagnostics module further comprising a transceiver operative to transmit the vehicle usage data to the server via the controller, the server comprising a database on which vehicle usage data is stored, the server further comprising a data processor controlled by an algorithm such that the server is operative to generate an alert signal by processing the vehicle usage data generated by the on-board diagnostics module and the road usage data stored on the database, the alert signal being indicative of a driving behaviour score.

Preferably the server is operative to transmit the alert signal from the server to the controller for review by the driver. The server and controller may be arranged such that the alert signal is transmitted to the controller such that the driver can review the driving score in real-time.

In one example, the on-board diagnostics module comprises a wireless transceiver operative to transmit and/or receive data from the controller wirelessly, the controller being provided on a separate mobile telecommunications device, such as a Smartphone for example. The wireless transceiver may comprise a Bluetooth® unit.

In another example, the on-board diagnostics module and controller are integral, the transceiver of the on-board diagnostics module comprising a mobile telecommunications transceiver operative to enable communication between the controller and the server via a mobile telecommunications network.

Preferably the on-board diagnostics module comprises a micro processor, a PCB, a flash memory, and a tri-axial accelerometer.

The on-board diagnostics module may be powered by its own internal battery, or comprise a suitable electrical connection to receive power from the vehicle.

The on-board diagnostics module may comprise an interface operative to connect with, and receive data from, the vehicle's European On Board Diagnostics (EOBD) port.

Preferably the on-board diagnostics module is operative to process a time signal and to obtain vehicle usage data at periodic time intervals, the on-board diagnostics module being operative to use the time signal to time stamp the vehicle usage data, and to send time stamped data packets of vehicle usage data to the controller.

The on-board diagnostics module may comprise a clock operative to generate its own time signal, or may receive a time signal generated from a clock on the controller or the server.

Preferably the on-board diagnostics module is operative to obtain vehicle usage data selected from one, some or all of the following vehicle usage characteristics:
a) Vehicle ignition-on and ignition-off events; and/or
b) Bluetooth device connection and disconnection events to/from EOBD port; and/or
c) Bluetooth power on and off events; and/or
d) Accelerometer data in three axes x, y and z; or and/or
e) Other data available from the appropriate vehicle management system.

The controller may comprise software or hardware on the mobile telecommunications device or the onboard diagnostics module, as appropriate. The controller may comprise a software application downloaded onto the mobile telecommunications device or the onboard diagnostics module.

The controller may also receive positional information from a GPS unit, the controller being operative to combine the positional information with the vehicle usage information from the on-board diagnostics module to form an aggregated vehicle usage data which is transmitted to the server.

The GPS unit may comprise a GPS unit on the mobile telecommunications device, or may comprise a GPS unit provided on the onboard diagnostics module.

Preferably the database on the server comprises data indicative of the road speed limit, the algorithm processing the vehicle usage data and the road speed limit data to generate the driving behaviour score.

The system may be capable of transmitting vehicle fault identifiers (to assist recovery services in the case of a breakdown) from the onboard diagnostics module.

According to a second aspect of the invention there is provided an on-board vehicle usage diagnostics module for use with a driving behaviour monitoring system, the on-board diagnostics module adapted to be mounted in a vehicle, and a vehicle usage monitor operative to monitor usage of the vehicle and to generate vehicle usage data based on at least one usage characteristic of the vehicle, the on-board diagnostics module further comprising a transceiver operative to transmit the vehicle usage data to a driving behaviour scoring server of the driver behaviour monitoring system via a controller, the controller and a server being arranged to be in real-time communication with the controller via a telecommunications network, the server comprising a database on which road usage data is stored, the server further comprising a data processor controlled by an algorithm such that the server is operative to generate an alert signal from processing the vehicle usage data generated by the on-board diagnostics module and from the vehicle usage data stored on the database, the alert signal being indicative of a driving behaviour score.

According to a third aspect of the invention there is provided a method of monitoring driving behaviour comprising steps of:
using an on-board diagnostics module adapted to be mounted in a vehicle to monitor usage of the vehicle;
generating vehicle usage data based on at least one usage characteristic of the vehicle, transmitting the vehicle usage data to a driving behaviour scoring server in real-time communication via a telecommunications network;
providing a database on which road usage data is stored;
controlling the server by an algorithm such that the server is operative generate an alert signal from processing the vehicle usage data generated by the on-board diagnostics module and from the vehicle usage data stored on the database, the alert signal being indicative of a driving behaviour score.

Other aspects of the present invention may include any combination of the features or limitations referred to herein.

The present invention may be carried into practice in various ways, but embodiments will now be described by way of example only with reference to the accompanying drawings in which:

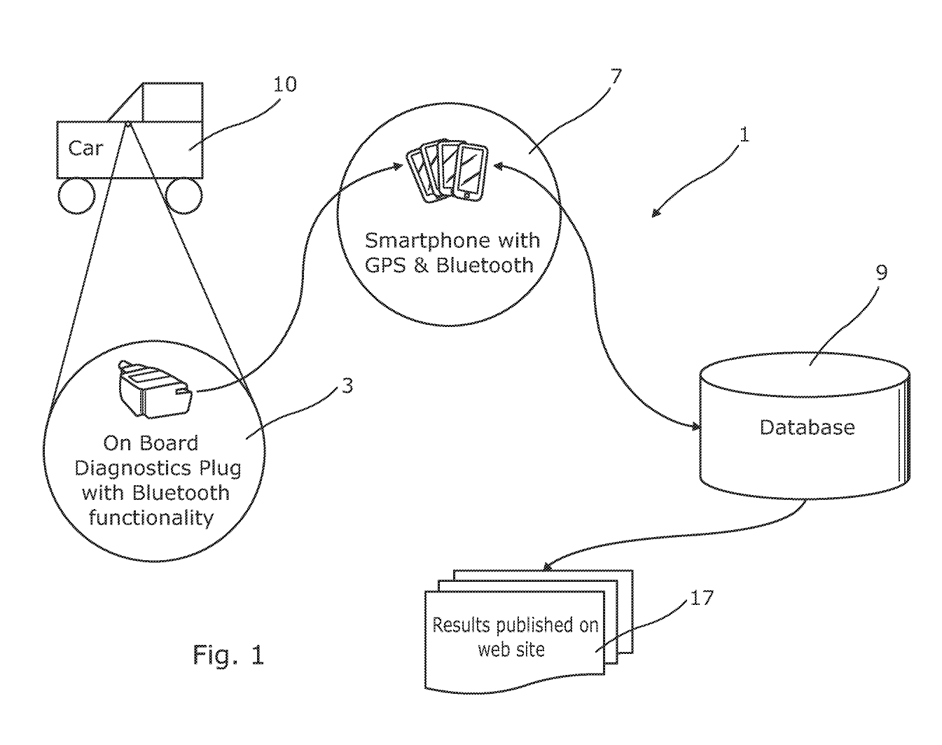

FIG. 1 is a schematic view of a driving behaviour monitoring system in accordance with the present invention; and

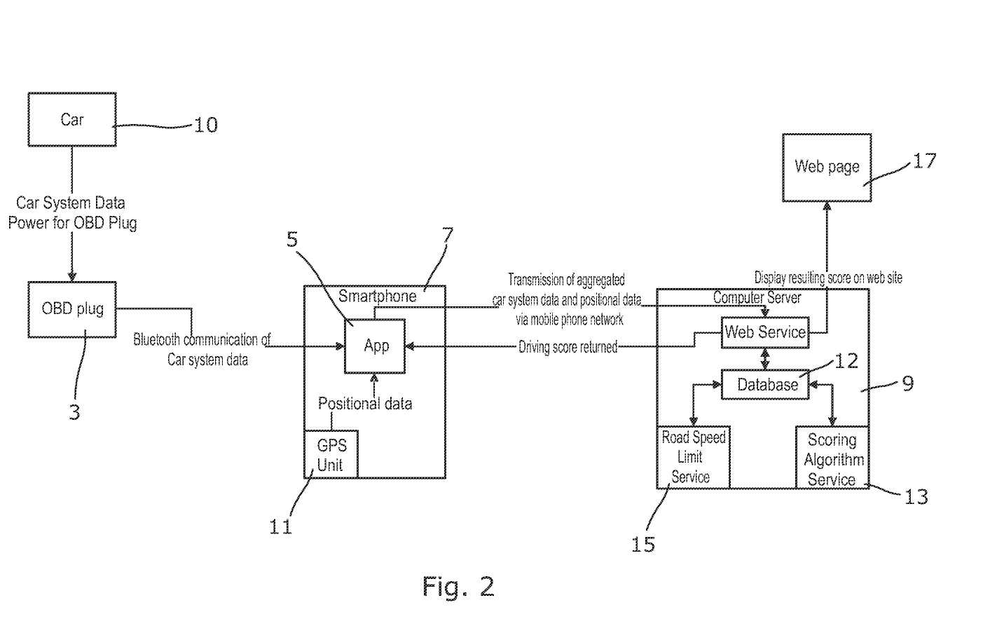

FIG. 2 is a control diagram of the system of FIG. 1.

A driving behaviour monitoring system 1 comprises an on-board diagnostics module 3, a controller 5, which in this example is in the form of a software application downloaded onto a mobile telecommunications device 7, and a server 9. The module 3 is provided with a wireless data transceiver such as a Bluetooth ® unit which wirelessly transmits vehicle usage data to the controller 5. The controller 5 transmits the vehicle usage data, optionally along with vehicle positional data obtained from a GPS unit 11 on the device 7 to the server 9 via a standard mobile telecommunications network as encrypted data. On-board diagnostics module 3 is adapted to be mounted on a vehicle 10 such that the on-board diagnostics module 3 cannot move relative to the vehicle 10, that is, so that the movement and forces of the vehicle 10 equal those of the on-board diagnostics module 3. The vehicle 10 may be provided with a suitable socket into which the on-board diagnostics module 3 can be inserted and retained.

The server 9 is operated remotely and comprises a database 12 on which vehicle usage data is stored, and from which a driving behaviour score is calculated, stored, and transmitted back to the controller and/or optionally to a linked website. The driving behaviour score is calculated by a software algorithm 13 on the server from the vehicle usage data generated by the on-board diagnostics module 3, the vehicle positional data if any, the vehicle usage data stored on the database 12, and optionally also from road speed limit data obtained from a road speed limit service 15.

The algorithm 13 is operative to generate an alert signal a score which rates the driving behaviour of the driver of the vehicle 10, in real-time, on a predetermined scoring system stored on the database 12. That algorithm 13 may reference other vehicle usage data prestored on the database 12 such as earlier scores of the driver in question, earlier scores for the vehicle in question, and any other desired data such as relating to manufacturer's stated vehicle performance, and the age of the vehicle for example. The score may be generated so as to provide the driver with an indicator of a driving or vehicle characteristic. That characteristic might be how safely the driver is driving, or how fuel economically the driver is driving.

The signal indicative of the driving behaviour score is transmitted from the server 9 to the controller 5 in real-time, via the mobile telecommunications network. The controller 5 may be operative to store the score for later review or may be operative to instantaneously display the score on the display of the mobile device 7, or an associated display of the onboard diagnostics module 3. The score may also be transmitted from the server 9 to a remote webpage 17 for later review either by the vehicle driver, or an external agency such as an insurance provider.

Preferably the controller 5 comprises a Smartphone software application downloaded onto the Smartphone 7, and the on-board diagnostics module 3 comprises a Bluetooth® slave device that wirelessly transmits data to the controller 5, that is, to the Smartphone 7.

The Smartphone application 5 is downloaded onto the driver's Smartphone 7. It is securely paired to the Bluetooth transceiver of on-board diagnostics module 3 using a unique code. The on-board diagnostics module 3 may also comprise an interface that enables the on-board diagnostics module 3 to receive data from the vehicle's European On Board Diagnostic's (EOBD) port.

Once the Smartphone 7 detects the Bluetooth on-board diagnostics module 3, the Smartphone application 5 may automatically start to record data, or may prompt the vehicle driver to allow the module 3 to begin recording data. The data recorded can include one, some or all of the following vehicle usage characteristics as time stamped events, time stamped at a periodic frequency as required:
a) Latitude
b) Longitude
c) Heading direction
d) Velocity
e) Attitude
f) Horizontal GPS accuracy
g) Vertical GPS accuracy

The on-board diagnostics module 3 comprises a Bluetooth® transceiver unit, a micro-processor, a printed circuit board, a flash-memory and may also comprise an EOBD interface, tri-axial accelerometer and/or an internal battery. The on-board diagnostics module 3 is operative to send periodic packets of time stamped vehicle usage data to the controller 5 indicative of one, some or all of the following vehicle usage characteristics:
Vehicle ignition-on and ignition-off events
Bluetooth® device connection and disconnection events to/from EOBD port
Bluetooth® power on and off events
Accelerometer data in three axes: x, y and z.
Other such data available from the appropriate vehicle management system

The controller 5 receives data wirelessly from the on-board diagnostics module 3 and aggregates this data to any vehicle positional data as may be recorded via the GPS unit 11 on the Smartphone. The Smartphone 7 transmits all (aggregated) vehicle usage data to the database 12 via machine-to-machine communication at a parameterised data recording frequency, using the mobile telecommunications network. The database 12 then generates a signal indicative of a driving behaviour score calculated inside the server 9 in real-time. The driving behaviour score may or may not be displayed via the Smartphone 7 to the driver, also in real-time.

By real-time, we mean as close as is possible to instantaneous, allowing for latency in data transmission time from the on-board diagnostics module 3 to the controller 5, from the controller 5 to the server 9, and vice versa, and also allowing for any processing time taken by the algorithm in the server 9. It is intended that the driver behaviour score be transmitted sufficiently quickly that the driver can modify his behaviour at that time, rather than waiting until after he has finished driving.

In relation to initiation of the communication link between the controller and the transceiver, this is achieved by way of the transceiver detecting when the controller is in range. This could be achieved by way of the transceiver issuing polling signals to determine whether the controller is in the vehicle. By arranging that the transceiver initiates the communication link, this ensures more efficient use of battery resource available for the controller. Otherwise, the controller would issue polling signals unnecessarily when it was not in the vehicle. In this manner, the transceiver serves as the master and the controller as the slave. Moreover, in the event that the controller is detected by the transceiver to be in range of the controller, but is not in the vehicle, the transceiver can look at other data, such as the RPM of the vehicle, and can determine whether data should be transmitted to the controller. If it is determined that the RPM is zero, the transceiver can determine that the vehicle is stationary and so no data needs to be transmitted to the controller.

The use of the slave on-board diagnostics module 3 removes the need for the Smartphone 9 to be affixed immovably to the vehicle, and thus alleviates any inaccuracy in accelerometer readings that might otherwise occur from the Smartphone 9 moving in use. The on-board diagnostics module 3 is adapted to be permanently or removably fixed to the vehicle, using any suitable form of bracket, fixing or plug-socket arrangement. The module may be embodied as a “bolt-on” or retro-fit component.

In an alternative embodiment, the onboard diagnostics module 3 is provided with the controller 5, the transceiver being a mobile telecommunication device transceiver operative to communicate with the mobile telecommunications network, and therefore the server 9, directly, without a mobile telephone 7 as an intermediary. In this instance the onboard diagnostics module 3 may comprise its own SIM and SIM card, and any other component of a mobile telephone as may be required.

1. A driving behavior monitoring system comprising:
an on-board diagnostics module adapted to be mounted in a vehicle, the on-board diagnostics module comprising:
a vehicle usage monitor operative to monitor usage of the vehicle and to generate vehicle usage data based on at least one usage characteristic of the vehicle;
a controller configured for communication with a driving behavior scoring server, the driving behavior scoring server arranged to be in real-time communication with the controller via a telecommunications network;
the on-board diagnostics module further comprising:
a transceiver operative to transmit the vehicle usage data to the server via the controller, the server comprising a database on which vehicle usage data is stored, the server further comprising a data processor controlled by an algorithm such that the server is operative to generate an alert signal by processing the vehicle usage data generated by the on-board diagnostics module and the road usage data stored on the database, the alert signal being indicative of a driving behavior score, and wherein the server is operative to transmit the alert signal from the server to the controller for review by the driver.

2. The system of claim 1, wherein the server and controller are arranged such that the alert signal is transmitted to the controller such that the driver can review the driving score in real-time.

3. The system of claim 1 wherein the on-board diagnostics module comprises a wireless transceiver operative to transmit and/or receive data from the controller wirelessly, the controller being provided on a separate mobile telecommunications device.

4. The system of claim 1, wherein the on-board diagnostics module and controller are integral, the transceiver of the on-board diagnostics module comprising a mobile telecommunications transceiver operative to enable communication between the controller and the server via a mobile telecommunications network.

5. The system of claim 1, wherein the on-board diagnostics module comprises a micro processor, a PCB, a flash memory, and a tri-axial accelerometer.

6. The system of claim 1, wherein the on-board diagnostics module is powered by its own internal battery, or comprises a suitable electrical connection to receive power from the vehicle.

7. The system of claim 1, wherein the on-board diagnostics module may comprise an interface operative to connect with, and receive data from, the vehicle's European On Board Diagnostics (EOBD) port.

8. The system of claim 1, wherein the on-board diagnostics module is operative to process a time signal and to obtain vehicle usage data at periodic time intervals, the on-board diagnostics module being operative to use the time signal to time stamp the vehicle usage data, and to send time stamped data packets of vehicle usage data to the controller.

9. The system of claim 1, wherein the on-board diagnostics module comprises a clock operative to generate its own time signal, or receives a time signal generated from a clock on the controller or the server.

10. The system of claim 1, wherein the on-board diagnostics module is operative to obtain vehicle usage data selected from one, some or all or more of the following vehicle usage characteristics:
Vehicle ignition-on and ignition-off events;
Bluetooth device connection and disconnection events to/from EOBD port;
Bluetooth power on and off events;
Accelerometer data in three axes x, y and z; and
Other data available from the appropriate vehicle management system.

11. The system of claim 1, wherein the controller comprises software or hardware on the mobile telecommunications device or the onboard diagnostics module, as appropriate.

12. The system of claim 11, wherein the controller comprises a software application downloaded onto the mobile telecommunications device or the onboard diagnostics module.

13. The system of claim 1, wherein the controller also receives positional information from a GPS unit, the controller being operative to combine the positional information with the vehicle usage information from the on-board diagnostics module to form an aggregated vehicle usage data which is transmitted to the server.

14. The system of claim 13, wherein the GPS unit comprises a GPS unit on the mobile telecommunications device, or comprises a GPS unit provided on the onboard diagnostics module.

15. The system of claim 1, wherein the server comprises data indicative of the road speed limit, the algorithm processing the vehicle usage data and the road speed limit data to generate the driving behavior score.

16. The system of claim 1 further arranged for use in determining premium adjustments and insurance ratings.

17. The system claim 1, wherein the transceiver is a retro fittable device.

18. An on-board vehicle usage diagnostics module for use with a driving behavior monitoring system, the on-board diagnostics module adapted to be mounted in a vehicle, and a vehicle usage monitor operative to monitor usage of the vehicle and to generate vehicle usage data based on at least one usage characteristic of the vehicle, the on-board diagnostics module further comprising a transceiver operative to transmit the vehicle usage data to a driving behavior scoring server of the driver behavior monitoring system via a controller, the controller and a server being arranged to be in real-time communication with the controller via a telecommunications network, the server comprising a database on which road usage data is stored, the server further comprising a data processor controlled by an algorithm such that the server is operative to generate an alert signal from processing the vehicle usage data generated by the on-board diagnostics module and from the vehicle usage data stored on the database, the alert signal being indicative of a driving behavior score, wherein the server is operative to transmit the alert signal from the server to the controller for review by the driver.

19. A method of monitoring driving behavior comprising:
using an on-board diagnostics module adapted to be mounted in a vehicle to monitor usage of the vehicle;
generating vehicle usage data based on at least one usage characteristic of the vehicle;
transmitting the vehicle usage data to a driving behavior scoring server in real-time communication via a telecommunications network;
providing a database on which road usage data is stored; and
controlling the server by an algorithm such that the server is operative generate an alert signal from processing the vehicle usage data generated by the on-board diagnostics module and from the vehicle usage data stored on the database, the alert signal being indicative of a driving behavior score, wherein the method further comprises the server transmitting the alert signal from the server for review by the driver.

20.-22. (canceled)
